(19) United States
(12) Patent Application Publication
(10) Pub. No.: US 2002/0070956 A1
(43) Pub. Date: Jun. 13, 2002

(54) Rule-driven guidance and feedback system

(75) Inventors: Yumman Chan, Rexdale (CA); Ramzan A. Khuwaja, Markham (CA); Kwong Tsang, Markham (CA); Jin Wang, Scarborough (CA)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 09/995,239

(22) Filed: Nov. 27, 2001

(30) Foreign Application Priority Data
Nov. 30, 2000 (CA) 2,327,191

(51) Int. Cl. G09G 5/00

(52) U.S. Cl. 345/714

(57) ABSTRACT

A reasoning model for a guidance and feedback system includes a decision graph built by an author to reflect a defined knowledge base. The decision graph includes nodes having rules to define links or transitions to other nodes in the graph. Nodes may be question nodes, recommendation nodes, or cross-sell nodes. Question nodes determine system user characteristics by direct interrogation or by indirect access to information about the user. Recommendation nodes are associated with question nodes and may be either final or interim. Cross-sell nodes provide information to a user that is not directly related to the defined knowledge base. A rule engine traverses the graph and fires the rules defined in the nodes. Links to nodes are followed in a manner determined dynamically as a result of the user data obtained at question nodes.

### FIELD OF THE INVENTION

The present invention is directed to an improvement in computing systems and in particular to a rule-driven guidance and feedback system.

### BACKGROUND OF THE INVENTION

As computer systems become more sophisticated they include help functions that permit users to obtain assistance in using the systems. Such user help systems are also popular in training and teaching applications where users are taken through various tutorials or predeteminded problems.

The user help systems in the prior art employ a model of user guidance which may depend on the context in which the help function is invoked by the user.

In certain systems, however, a more complex form of user guidance is desirable. This is particularly the case for electronic commerce (e-commerce) applications where users are potentially presented with complex choices. In such e-commerce applications it is also desirable to be able to personalize the presentation of information for consumers or shoppers. The personalization of websites in web-based e-commerce is thought to increase consumer loyalty. Such systems, particularly in the consumer context, prompt users for information and present personalized recommendations or selected information to users in response to the information obtained. Such guidance and feedback computer systems may implement a form ofuser (or consumer/shopper) guidance similar to the help functions referred to above. However, in such complex interactive internet environments, the assistance offered by such help function user guidance systems are limited and lack flexibility.

One approach to personalizing the interface for an e-commerce websites is to use collaborative reasoning. This prior art approach determines the recommendations to make to a consumer or user based on previous consumer choices. Although user behavior is captured in such a model, business or marketing decisions made by the website owner or author are difficult to incorporate into this model. An alternative to the collaborative model is the use of database technology. Systems using this technology rely on a series of database tables that allow parametric searches to generate a recommendation for a consumer. For complex systems, however, this technique requires a potentially prohibitively exhaustive list of data points to provide sophisticated recommendations to users. Another approach is to encapsulate heuristic reasoning for recommendations in functional programming language code. This type of system may provide sophisticated recommendations but it is difficult to build, change and maintain such a system. This type of system also requires a computer-knowledgeable person to be involved with the design and maintenance of the system.

It is therefore desirable to have a guidance and feedback system that presents recommendations to users based on user information, that is intuitive to those familiar with the knowledge base, and that responds to user information in a sophisticated and flexible manner.

### SUMMARY OF THE INVENTION

According to an aspect of the present invention there is provided an improved computer system for providing recommendations to users.

According to another aspect ofthe present invention there is provided a computer system reasoning model component for generating user recommendations for a defined knowledge base, the component including:

a component for storing, maintaining and representing a decision graph definable by an author, the decision graph including nodes and links between the nodes, the nodes including:

a set of decision nodes, and a set of feedback nodes, each of the nodes in the decision graph including rules defined by the author

to define links to other nodes in the graph, and

for a decision node, to request and obtain user information, and

for a feedback node, to provide feedback to users, and a component to traverse the decision graph and fire or invoke the rules defined in the graph nodes.

According to another aspect of the present invention there is provided the above computer system component in which the decision nodes include question nodes and the feedback nodes include recommendation and promotion nodes.

According to another aspect of the present invention there is provided the above computer system component in which promotional nodes include cross-sell and up-sell nodes.

According to another aspect of the present invention there is provided the above computer system component in which the nodes do not contain information relating to presentation of data to the user.

According to another aspect of the present invention there is provided the above computer system component in which the rules defining links to other nodes in the graph include rules potentially accessing and evaluating one or more of:

a) personalization choices collected implicitly or explicitly from the user,

b) static data relating to the user,

c) a dynamically generated user model,

d) attributes of elements in the knowledge base, and

e) author-related goals.

According to another aspect of the present invention there is provided the above computer system component in which the decision graph includes multiple entry points.

According to another aspect of the present invention there is provided the above computer system component in which the decision graph includes nodes potentially chaining the decision graph to other decision systems.

According to another aspect of the present invention there is provided the above computer system component in which the rules defining links between nodes in the decision graph potentially utilize one or more of:

f) weighting systems,

g) fuzzy logic systems, and

h) probabilistic reasoning.

According to another aspect of the present invention there is provided a computer system reasoning model component for generating user recommendations for a defined knowledge base, the component including:

a component for storing, maintaining and representing a decision graph definable by an author, the decision graph including nodes and links between the nodes, the nodes including

a set of decision nodes, and a set of feedback nodes, the decision nodes including question nodes and the feedback nodes including recommendation and promotion nodes each of the nodes in the decision graph including rules defined by the author

to define links to other nodes in the graph, and for a decision node, to request and obtain user information, and for a feedback node, to provide feedback to users, the rules defining links to other nodes in the graph including rules potentially accessing and evaluating one or more of:

(a) personalization choices collected implicitly or explicitly from the user,

(b) static data relating to the user,

(c) a dynamically generated user model,

(d) attributes of elements in the knowledge base, and

(e) author-related goals.and potentially utilize one or more of:

(i) weighting systems,

(ii) fuzzy logic systems, and

(iii) probabilistic reasoning, and a component to traverse the decision graph and fire the rules defined in the graph nodes.

According to another aspect of the present invention there is provided a computer program product for providing user recommendations, the computer program product including a computer usable medium having computer readable code means embodied in said medium, including computer readable program code means for implementing the system components described above.

It will be appreciated by those skilled in the art that the computer program can be stored in storage or transmitted as a signal, such as on a modulated carrier signal for use in a computer system, or on a network such as the Internet for use in a computer system.

Advantages of the present invention include a system that is intuitively useable by authors to guide users topersonalizedrecommendations foragivenknowledgebase. Thereasoningmodel is flexible and is designed to permit user input to dynamically determine the recommendations to be provided to the user.

### BRIEF DESCRIPTION OF THE DRAWINGS

FIG. 1 is a block diagram showing the context in which the reasoning model of the preferred embodiment may be used.

FIG. 2 is a graph showing an example arrangement of nodes in a decision graph constructed in the reasoning model of the preferred embodiment.

### DETAILED DESCRIPTION OF THE PREFERRED EMBODIMENT

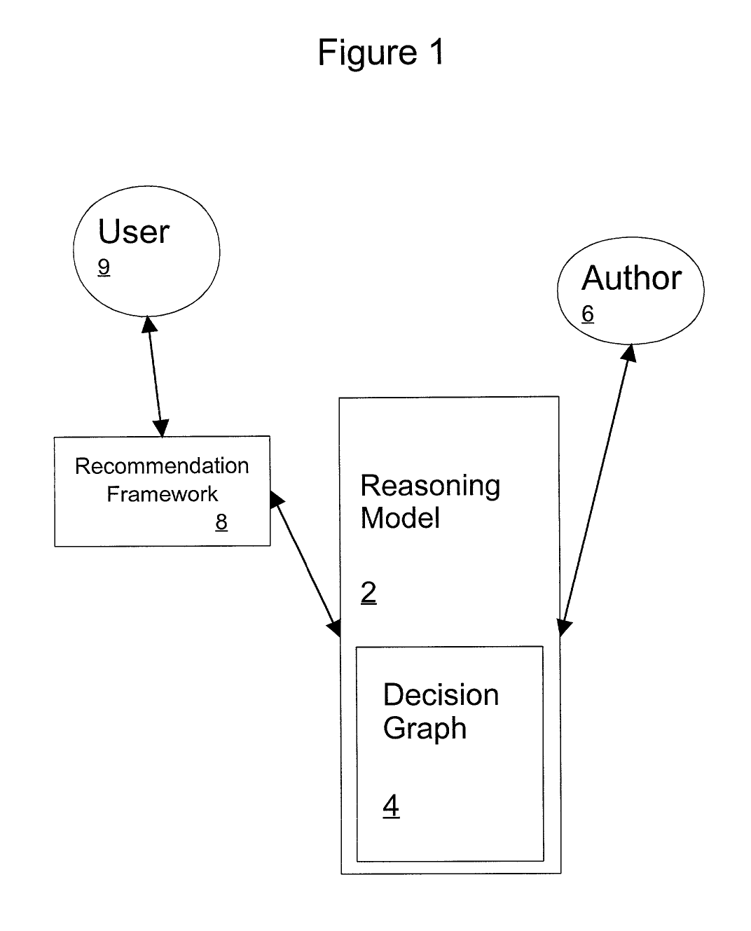

FIG. 1 shows, in a block diagram format, the context in which the reasoning model ofthe preferred embodiment may be utilized. FIG. 1 shows reasoning model 2, including decision graph 4. Author 6 in FIG. 1 defines decision graph 4. Recommendation framework 8 takes information from reasoning model 2 to provide a front-end for a guidance and feedback system for user 9. Reasoning model 2 is used by framework 8 to determine how guidance and feedback is to be provided to user 9.

One application for the preferred embodiment is in an environment in which author 6 will use reasoning model 2 to define recommendations for consumers (shoppers) using a website defined by framework 8. In such an application, the website may be a buy-side e-commerce application and author 6 may be a merchant, business expert or marketing expert or a developer working with such people having knowledge of shopping patterns and merchant characteristics. The preferred embodiment may also be implemented for other applications where recommendations based on information received from a user are to be provided to the user on a computer system. Business to business internet systems and other interactive guidance and feedback systems may utilize the preferred embodiment.

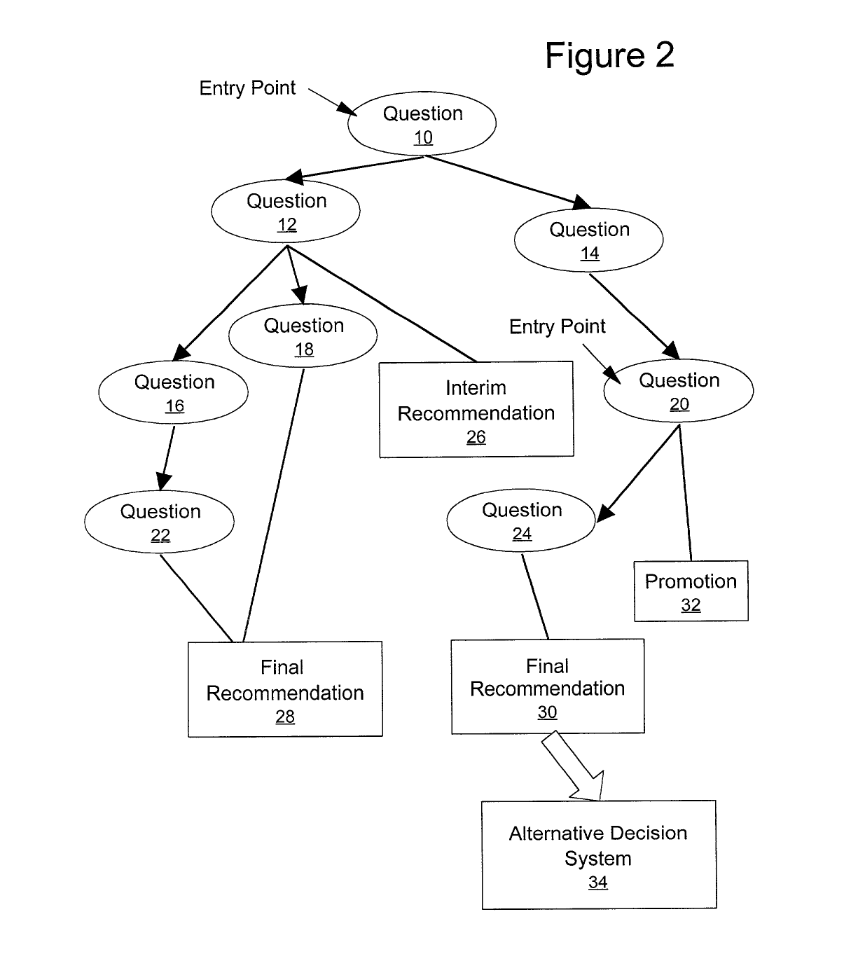

FIG. 2 shows an example decision graph generated using the reasoning model of the preferred embodiment. Reasoning model 2 may implement decision graph 4 (an example of which is shown in FIG. 2) in a manner appropriate for the environment in which the reasoning model is to be run. Reasoning model 2 provides the interface to recommendation framework 8 and an interface usable by author 6 to display, create and modify decision graph 4.

The decision graph of FIG. 2 includes question nodes 10, 12, 14, 16, 18, 20, 22, 24 as well as interim recommendation node 26, final recommendation nodes 28, 30 promotion node 32, and alternative decision system 34. In the terminology of the preferred embodiment, the question nodes are referred to as decision nodes and the interim recommendation, final recommendation and promotion nodes are referred to as feedback nodes.

As referred to above, the preferred embodiment provides a reasoning model that may be used in an e-commerce environment. The description of the preferred embodiment is described here in terms of a distributed computing environment component that is accessed by a framework or by an e-commerce front-end system. The component of the preferred embodiment is called by the framework to determine what prompts and information to display to a user. In the context of a web-based system, the reasoning model component of the preferred embodiment will accept and return tokens to a recommendation framework/webserver (the e-commerce front end) that displays HTML pages to a browser. The front-end or framework with which the reasoning model communicates has a mechanism for generating system responses provided to a consumer and a mechanism for collecting responses received from a consumer. The preferred embodiment uses the IBM Recommendation Assistant Framework (TM) as a front-end.

In operation, the reasoning mode component may access databases or other systems or components or it may simply provide data to the front-end component that may itself make direct use of such databases or other components. Alternatively, the reasoning model of the preferred embodiment may be included as an integral part of a single component or system. Those skilled in the art are able to implement the reasoning model of the preferred embodiment in the appropriate environment.

The decision graph shown in FIG. 2 is an example corresponding to decision graph 4 in FIG. 1. The example decision graph illustrates how a decision-making process to be reflected in a guidance and feedback or recommendation system is represented using reasoning model 2 of the preferred embodiment. Graphs such as that shown in FIG. 2 are able to be built (by author 6) for a website or other application in which recommendations are to be provided (to user 9). The domain knowledge relating to the website or other application is encapsulated in the nodes and links between nodes that form the decision graph.

In the example of FIG. 2, nodes 10 and 20 are entry points for the graph. An entry point is defined as a node that is traversed first when the reasoning model begins execution. The ability of a single decision graph to have multiple entry-points permits a single decision graph to be accessed from different contexts. This will be done where different web pages or sites seek to provide recommendations based on the same domain knowledge. An example where multiple entry points are provided is where recommendations about a line of products are made to both employees of a company (shopping on-line from a company intranet) and to the public (shopping on-line from an on-line merchant site). The same decision graph can be used for both sets of consumers, but the information to be obtained from the consumer, and the interim recommendations, may vary and therefore the starting points in the graph are potentially different for the two groups of consumers.

The entry point nodes 10, 20 in FIG. 2 are also question nodes (shown as ovals in the graph). At question nodes information is obtained from, or relating to, the consumer (user 9 in FIG. 1). The question node will define what information is to be obtained and from what source the information is to come. An example is a question posed to a consumer using a web-based interface. The question defined in node 10, for example, may be a request for a consumer's preferred customer number. The framework or e-commerce front-end using the decision graph is passed data defining the question and displays the appropriate text to the consumer. The consumer inputs the answer which is in turn passed to the reasoning model of the preferred embodiment. Node 10 defines what step is then to be taken based on the input provided by the consumer in response to the question defined in node 10. For example, if the preferred customer number indicates that the consumer is a corporate customer, different choices and recommendations will be made available than if the consumer is a retail customer. Different portions of the graph are therefore used, depending on the input received.

The links or edges in the decision graph are made by author 6 and are traversed based on data in the knowledge base as augmented by data input by the consumer. For example, links from a node in a decision graph may be defined to be selectively traversed based on a consumer's response to questions defined in the question node, or to a history of responses to previously answered questions (from nodes previously reached in the graph), or based on a dynamically generated user model that is incrementally updated as responses are input by the consumer. Other possible factors that can be used to define the link or edge to be followed in the decision graph include stored profiles of the individual consumer or of the class of consumer, data relating to attributes and properties of one or more products or services related to the knowledge base, and business goals of the merchant (to reduce inventory, for example). Sophisticated usermodels based on weighting systems, fuzzy logic, or probabilistic reasoning may be used in determining the transition to use from one node to another.

As can be seen in FIG. 2, a question node may have a single defined link or edge, as is the case for node 14 (linked to node 20), or multiple links as shown for node 12 (links to nodes 16, 18). A question (or decision) node may also have links to recommendation nodes. The recommendation nodes in the preferred embodiment may be either interim or final recommendation nodes. A final recommendation node is not able to link to other nodes within the graph and is typically a leaf in the tree defined by the decision graph. Examples in FIG. 2 are nodes 28, 30. As can also be seen from the example of node 28 in FIG. 2, multiple question nodes may link to a single recommendation node (in FIG. 2 both nodes 18, 22 link to node 28).

As is shown in FIG. 2, a final recommendation node may contain a link to a different decision system. In FIG. 2, node 30 contains a link to an alternative decision system 34. In the preferred embodiment, such links are specified by a URL in the leaf node that is used to redirect a browser to a different decision system. The different decision system may be a different decision graph for the same system as in the preferred embodiment. In this way, decision based systems may be chained. This permits a user to seamlessly move from one recommendation system, or decision graph, to another.

Node 26 in FIG. 2 is defined to be an interim recommendation node. An interim recommendation node is linked to a question node but is intended to present a recommendation to a consumer based on incomplete information. The decision graph generated is predicated on a more accurate recommendation being available to the consumer after further question nodes are traversed. The interim recommendation node is included where the author considers that the consumer may be losing interest in continuing to use the system or where the information returned from question nodes that follow in the graph are expected to be subject to diminishing returns. Typically, a recommendation at a leaf node, or near a leaf node, is a more refined recommendation than is an interim recommendation nearer an entry point in the graph.

FIG. 2 also shows a promotion node 32. A promotion node is a feedback node like a recommendation node but is defined to reflect the promotional plans of the e-commerce seller (the author in the figures). A promotional node maybe a cross-sell node in which consumers are directed to a product or service that is potentially of interest to the consumer but is not the product or service that the consumer is receiving recommendations about. Alternatively, a promotional node may include “up-sell” information or other promotional marketing material.

In a typical application for the preferred embodiment, the knowledge domain relates to an on-line shopping environment. The author will define questions relating to shopper characteristics for question nodes in the decision graph. By defining the links between the nodes to reflect the shopper and product characteristics the shopper is guided to products of interest. In this way, the reasoning model will be populated for a specific merchant and the guidance and recommendations will be personalized for the shopper. The system front-end accesses the reasoning model having the defined decision graph to provide prompts and questions to the shopper and to accept input in response.

The nodes in the decision graph contain rules determined at build time (by the author). The links or transitions actually followed are determined dynamically at runtime by those rules defined in the nodes. In the preferred embodiment, at run time a rule engine traverses the decision graph and fires rules based on the node definitions at reached nodes. The rules in effect implement a decision graph router. The use of rule based technology is a natural implementation of the reasoning model of the preferred embodiment. However, other programming models such as Java or C++are also able to implement the reasoning model and permit the definition and use of a decision graph as described above. The traversal of the decision graph simulates the heuristic reasoning used by a merchant or other business expert in the knowledge domain for which the decision graph is constructed.

The nodes of the decision graph contain data relating to questions, answers, hints and suggestions, as well as the rules for moving to another node in the graph. In one embodiment of the invention, the decision graph does not itself contain presentation information. For example, the visual design of a page to be presented to a consumer is not defined within the nodes of the decision graph. Although such display or presentation information could be included in a decision graph implementing the invention, it is potentially advantageous to separate the substance of the decision graph from the presentation data. It is often the case that pages or interface specifications are generated dynamically at runtime and different views or presentation modes are possible for the same substance. Defining the decision graph of the reasoning model to have only substance data, rather than presentation data, facilitates polymeric views and permits an intuitive two-phase design in which the substance and the presentation may be considered separately.

In the first phase of the design, the author is able to focus on the reasoning aspects of the model first (the structure and inferencing rules) and secondly to focus on creating the substance (the questions to be asked). In the second phase the author determines the presentation details of how the substance is to be presented to a user and the user responses collected.

The reasoning model of the preferred embodiment thus permits business and marketing experts to define business rules in a decision graph that is able to mimic their reasoning. The use of rule technology in defining the reasoning model provides a natural mechanism for the development of a guidance and feedback system or component as described above.

Although a preferred embodiment of the present invention has been described here in detail, it will be appreciated by those skilled in the art that variations may be made thereto without departing from the spirit of the invention or the scope of the appended claims.

The embodiments of the invention in which an exclusive property or privilege are claimed are defined as follows:

1. A computer system reasoning model component for generating user recommendations for a defined knowledge base, the component comprising;
a component for storing, maintaining and representing a decision graph definable by an author, the decision graph comprising nodes and links between the nodes, the nodes comprising;
a set of decision nodes, and a set of feedback nodes, each of the nodes in the decision graph comprising rules defined by the author
to define links to other nodes in the graph, and
for a decision node, to request and obtain user information, and
for a feedback node, to provide feedback to users, and
a component to traverse the decision graph and fire the rules defined in the decision graph nodes.

2. The computer system component of claim 1 in which the decision nodes comprise question nodes and the feedback nodes comprise recommendation and promotion nodes.

3. The computer system component ofeclaim 2 in which promotional nodes comprise cross-sell and up-sell nodes.

4. The computer system component of claim I in which the nodes contain no information relating to presentation of data to a user.

5. The computer system component of claim I in which the rules defining links to other nodes in the graph comprise rules accessing and evaluating one or more of:
a) personalization choices collected implicitly or explicitly from the user,
b) static data relating to the user,
c) a dynamically generated user model,
d) attributes of elements in the knowledge base, and
e) author-related goals.

6. The computer system component of claim 1 in which the decision graph comprises multiple entry points.

7. The computer system component of claim 1 in which the decision graph comprises nodes potentially chaining the decision graph to other decision systems.

8. The computer system of claim 1 in which the rules defining links between nodes in the decision graph utilize one or more of:
a) weighting systems,
b) fuzzy logic systems, and
c) probabilistic reasoning.

9. A computer system reasoning model component for generating user recommendations for a defined knowledge base, the component comprising:
a component for storing, maintaining and representing a decision graph definable by an author, the decision graph comprising nodes and links between the nodes, the nodes comprising:
a set of decision nodes, and a set of feedback nodes, the decision nodes comprising: question nodes and the feedback nodes comprising recommendation and promotion nodes, each of the nodes in the decision graph comprising rules defined by the
author to define links to other nodes in the graph, and
for a decision node, to request and obtain user information, and
for a feedback node, to provide feedback to users, the rules defining links to other nodes in the graph comprising rules accessing and lo; i evaluating one or more of:
(f) personalization choices collected implicitly or explicitly from the user,
(g) static data relating to the user,
(h) a dynamically generated user model,
(i) attributes of elements in the knowledge base, and
(j) author-related goals; and utilize one or more of:
(i) weighting systems,
(ii) fuzzy logic systems, and
(iii) probabilistic reasoning, and a component to traverse the decision graph and fire the rules defined in the graph nodes.

10. A computer program product for providing user recommendations, the computer program product comprising a computer usable medium having computer readable code means embodied in said medium, comprising computer readable program code means for implementing the system component of any of claims 1 to 10.

11. The computer program product of claim 10 wherein said computer readable code means comprises a computer readable signal and said medium comprises a computer readable signal-bearing medium.

12. The program product of claim 1 1 wherein said medium is a recordable data storage medium.

13. The product of claim 11 wherein said medium is a modulated carrier signal.

14. The product of claim 13 wherein said signal is a transmission over a network.

15. A computer program comprising computer program code means adapted to establish the components of claim 1 when said program is run on a computer system.
